(19) United States
(12) Patent Application Publication
(10) Pub. No.: US 2012/0319846 A1
(43) Pub. Date: Dec. 20, 2012

(54) Combination Bio-Sensing and Proximity Switch

(76) Inventor: Leif Rogers, Beverly Hills, CA (US)

(21) Appl. No.: 12/847,770

(22) Filed: Jul. 30, 2010

(51) Int. Cl. G08B 23/00

(52) U.S. Cl. 340/573.1

(57) ABSTRACT

A combination switch and communication device/sensor safety device that prohibits an exercise, or similar machine, or any power equipment or machine from running while a person is not correctly positioned to operate it. A proximity sensor in combination with a biological sensor are worn by the user. A receiver switches the machine off if a positive signal is not received from both biological sensor and from the proximity sensor thus shutting down the machine if the user is not safely positioned to operate it.

### BACKGROUND

1. Field of the Invention

The present invention relates generally to safety switches and more particularly to a combination bio-sensing and proximity switch.

2. Description of the Prior Art

Unsafe or careless use of motorized exercise equipment and other home machinery can lead to serious accidents. To address such events, “dead-man-switches” have been created and sometimes sold as components of such machinery. Many of these switches comprise a key or metal peg tethered to the user, with the other end inserted into a receptacle, creating an electrical circuit when the switch is activated. If the user falls off of or moves suddenly away from the machine, the machine will shut down. Other such devices use other technology to detect the presence of a user in position in proximity of the equipment.

U.S. Pat. No. 6,135,924 teaches an exercise treadmill machine in which an optical sensor monitors the position of a user on the treadmill and automatically varies the speed of the treadmill to keep the user near a predetermined position on the treadmill's endless belt. The optical sensor preferably includes an infrared (IR) emitter and an IR detector, which are located in or near the treadmill control panel that also houses a preprogrammed microprocessor. The microprocessor controls the speed of the belt as required to adjust for variations in the position of the user.

U.S. Pat. No. 6,824,502 teaches a body temperature actuated treadmill operation mode control arrangement that includes two body-temperature movement detection circuits respectively formed of a pyroelectric effect sensor, a resistor, and a capacitor, and adapted to detect the presence of the moving left hand or right hand of the user, a signal amplifier adapted to amplify the output signal of each body temperature movement detection circuit, and a microprocessor adapted to control the speed of the walking belt control motor and the forward/backward rotation of the tilting control motor of the treadmill subject to the output signal from the right body temperature movement detection circuits.

U.S Pat. No. 6,605,045 teaches a pulse wave sensor includes a detecting element and a sensor body. The pulse wave sensor is worn on the back side of a user's wrist corresponding to the back of the user's hand. The detecting element includes a translucent member on its top, and the translucent member has a convex surface. The detecting element is attached on the back of the user's wrist by a dedicated belt so that the convex surface of the translucent member is in intimate contact with the surface of the user's skin. The sensor body is attached on the back of the user's wrist by another dedicated belt so that it is arranged on the detecting element. A cushion is arranged between the sensor body and the detecting element. The pulse wave sensor can stably detect the pulse wave without being affected by the movement of the user's wrist.

U.S. Pat. No. 6,434,421 teaches a method and apparatus for biopotential sensing and stimulation which includes a sensory component, a biopotential sensor electrode, and a biopotential sensory electrode system. Stimulation components may also be included to provide stimulation signals to the biopotential signal source. The interface transfers signals to external instrumentation using wireless or wired connections. The power source includes batteries, solar cells, and telemetry power sources. The biopotential sensory electrode system includes electrode arrays and a receiver section that transfers biopotential signals among the biopotential signal source and external instrumentation and equipment.

U.S. Patent Application No. 20100093492 teaches an exercise device configured to sense and respond to objects in proximity to the exercise device. The device includes a sensor configured to sense objects in proximity to the exercise device other than the user who is operating the exercise device. A console is in communication with the sensor that instructs components of the treadmill to provide, for example, an audible and/or visual response to the user of the exercise device, or to slow or stop the exercise device from moving.

U.S. Patent Application No. 2008/0287816 teaches an adjustable sensor for use with exercise apparatus. An example apparatus includes a support frame to assist a user in an exercise and a sensor integral with the support frame. The sensor is to detect a physiological condition of the user through physical contact with the user, and a position of the sensor is adjustable by the user.

All of these prior art devices include reliance on a mechanical connection between the user and the safety on-off switch in order to function. This is a serious drawback since these devices will shut down equipment when disconnected from the machine, but not when disconnected from the user.

In many of the examples of prior art, a key is used as an electrical contact at the machine-end of the device, and a clip is employed at the human end. The user can neglect to attach the clip to his or her body rendering the safety device useless. In other examples of the prior art, proximity sensors or the like, are employed.

It would be advantageous to have a switch that prohibits a machine from working if the device is not attached to the operator by detecting the presence of a human being and also by detecting a safe position for the human being to operate the machine. None of the prior art offers the combination of bio-sensing in combination with proximity sensing.

### SUMMARY OF THE INVENTION

The present invention relates to a bio-sensing and proximity switch that works by detecting the presence of a human being and also by detecting a safe position for the human being to operate a machine. The combination of these two sensors makes the present invention unique. The present invention also affords the user the convenience of only one connection; that which is achieved by merely donning the device.

Embodiments of the present invention include a wireless safety device that automatically stops an article of exercise equipment or other machine when it senses that a person is not correctly positioned to operate it or not in proximity to it. It offers a combination of three main features: bio-sensing, proximity-sensing, and automatic shut-down. The sensor can be worn on the body for the purpose of communicating a person's proximity to an exercise machine. If the user is not safely positioned to operate the machine, and/or not wearing the safety sensor device, a receiver switches the machine off or otherwise disables it.

The present invention generally employs bio-sensing in combination with proximity-sensing to transmit to the receiver that the user is wearing the safety device, and that the user is in a proper position to operate the machine. The present invention can also signal a change in the user's state. Components such as bio-sensors are found in electronic heart-rate and blood-pressure monitors. These sensors are common and can be employed in this invention. The sensor recognizes the device's contact with living tissue and sends a signal to the receiver.

Because there are no wires or tethers involved, there is no risk of deactivating the sensor by accidentally disconnecting a wire or tether. The embodiment mounts on a user's head, wrist or any other part of the body. The invention can be used with any power equipment including power tools, factory machinery, heavy equipment or the like.

### DESCRIPTION OF THE FIGURES

Attention is now directed to several drawings that illustrate features of the present invention.

FIG. 1 is a front perspective view of the embodiment including a monitor comprising a bio proximity switch and a bio sensitive signal creator and receiver.

FIG. 2 is a cut-away view illustrating the embodiment including a monitor, which comprises a bio-proximity switch and a bio-sensitive signal creator and receiver.

FIG. 3A is a perspective view of the embodiment worn on the wrist.

FIG. 3B is a perspective view of the embodiment worn on the head.

Several drawings and illustrations have been presented that aid in understanding the present invention. The scope of the present invention is not limited to what is shown in the figures.

### DESCRIPTION OF THE INVENTION

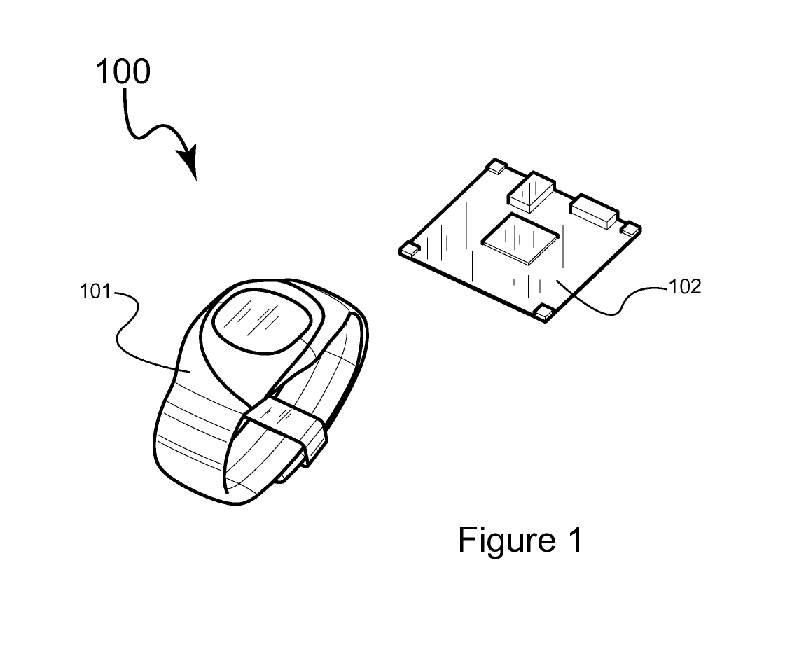

Embodiments of the present invention are illustrated in FIGS. 1-3B. Referring to FIG. 1 an embodiment 100 is shown mounted on a wristband and comprises a number of sensors capable of sensing contact with living tissue such as heart rate, body temperature, electrical skin resistance or any other biologically detectable state. This embodiment further comprises a signal-sending apparatus that works in combination with a receiving unit 102. The receiving unit 102 can be a radio frequency identification reader (RFID), a BLUETOOTH receiver or any other wireless receiver coupled to a switch that can control the machine or any combination of such receivers. The switch can be coupled to a central processing unit (CPU), a processor, a circuit, or to any other device that can control and disable the machine.

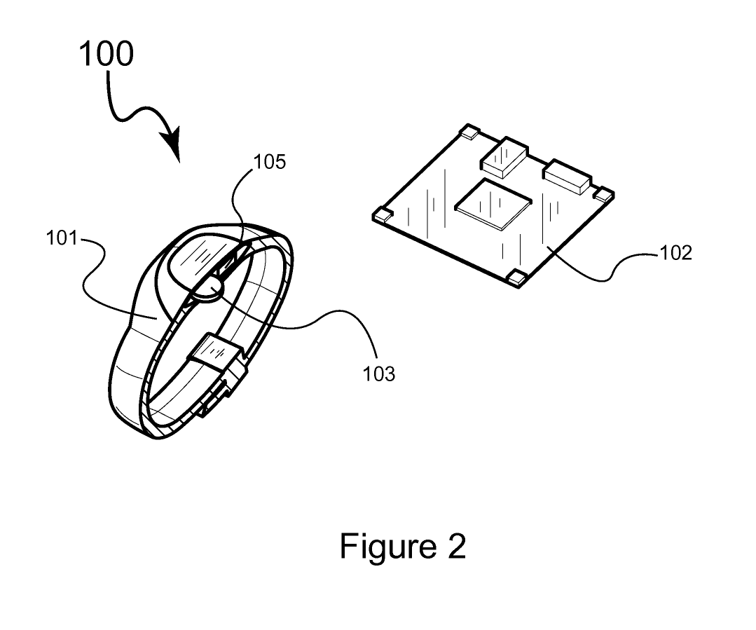

FIG. 2 shows an embodiment 100, shown in cut-away view, containing a proximity tag 103 and a bio-sensor 105 that recognizes contact with the human body. The sensor(s) recognize that the device is in contact with living tissue and sends a signal to the receiver 102. The receiver 102 is designed to receive a signal from the bio-sensor and also to recognize the proximity of the proximity tag 103. When both a positive signal from the proximity sensor and the bio-sensor are received, the receiver activates a power switch which then turns on the machine or otherwise allows the machine to operate. Loss of either of these sensor inputs results in a signal or loss of signal that causes the machine to shutoff or otherwise disable. It is within the scope of the present invention to combine the sensor outputs into a single transmitter and only transmit one signal when both sensors have outputs that show correct bio-sensing and correct proximity. The signal or signals are wireless and can be radio signals, light signals or any other type of wireless signal. The preferred signal is a low powered radio signal.

The device of the present invention can also use a typical RFID tag to register proximity. In this embodiment, the bio-sensor makes sure the device is in contact with the person, and the RFID tag, just be being close to an RFID receiver, makes sure of proximity. In this case, the receiver contains both an RFID reader and a receiver module to receive the signal from the bio-sensor. The RFID tag can be either passive or active.

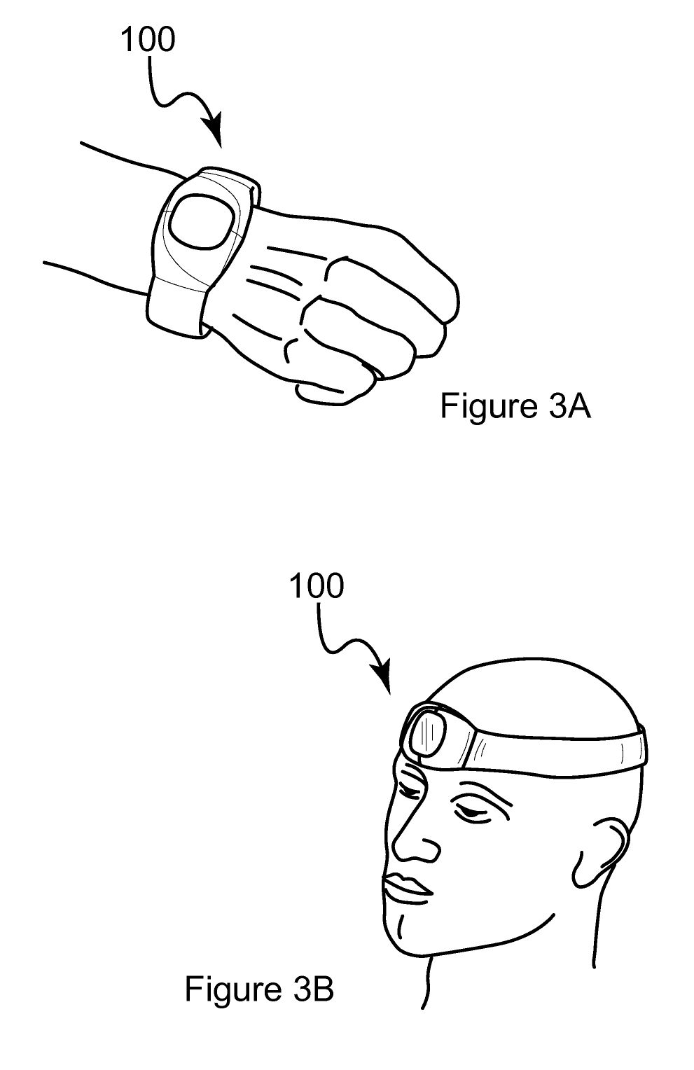

FIG. 3A shows an embodiment of the present invention 100 on the wrist, while FIG. 3B shows the device 100 worn on the head. Although the device of the present invention is shown in these two configurations, this is not intended to limit the manner in which the device may be worn. A flexible, adjustable strap such as that shown on the head in FIG. 3B, can be made to hold the device to the chest or waist of the user, or a wrist band can also be worn on an ankle or elsewhere. It is within the scope of the present invention to wear the device 100 anywhere on the body that the sensors can sense body contact.

Several descriptions and illustrations have been provided to aid in understanding the present invention. One with skill in the art will realize that numerous changes and variations are possible without departing from the spirit of the invention. Each of these changes and variations is within the scope of the present invention.

I claim:

1. A safety on-off switch comprising:
in combination, a sensor sensing biological function and sending a first signal, and a sensor sensing proximity and sending a second signal;
a receiver controlling a machine receiving said first and second signals, said receiver only allowing said machine to operate when both said first signal and said second signal are simultaneously present.

2 The safety on-off switch of claim 1 wherein said first and second signals are radio signals.

3. The safety on-off switch of claim 1 wherein said proximity sensor is an RFID tag.

4. The safety on-off switch of claim 1 wherein said biological function is a pulse rate signal.

5. A machine safety switch comprising:
a housing worn by a user;
a bio-sensor mounted in said housing positioned to detect when said housing is in contact with a human or animal body;
a proximity sensor also mounted in said housing, said proximity sensor adapted to detect when said housing is in a predetermined proximity of said machine;
at least one signal transmitter in said housing transmitting a signal operationally coupled to said bio-sensor and said proximity sensor, said signal transmitter transmitting at least one wireless signal;
a wireless receiver operationally coupled to said machine such that said receiver can enable and disable said machine, said wireless receiver receiving said wireless signal and only enabling said machine to operate when said bio-sensor reports contact with said body and said proximity sensor reports said predetermined proximity.

6. The machine safety switch of claim 5 wherein said proximity sensor is an RFID tag.

7. The machine safety switch of claim 5 wherein said signal is a radio signal.

8. The machine safety switch of claim 7 wherein said radio signal is a BLUETOOTH signal.

9. The machine safety switch of claim 5 wherein said proximity sensor is a passive RFID tag, and said signal is a BLUETOOTH radio signal.

10. A method of protecting a user from injury on a machine comprising:
providing said user with a device containing a bio-sensor and a proximity sensor, wherein said bio-sensor senses contact with said user and said proximity sensor senses a predetermined proximity to said machine;
providing a receiver on said machine adapted to receive signals from said bio-sensor and said proximity sensor and only enabling said machine when said bio-sensor is in contact with said machine and said proximity

11. The method of claim 10 wherein said bio-sensor senses pulse rate, skin temperature or electrical skin resistance.

12. The method of claim 10 wherein said signals are radio signals.

13. The method of claim 12 wherein said radio signals are RFID signals or BLUETOOTH signals.

14. The method of claim 10 wherein said device is worn on the user's wrist or forehead.
